(19) United States
(12) Patent Application Publication
(10) Pub. No.: US 2024/0389660 A1
(43) Pub. Date: Nov. 28, 2024

(54) ELECTROMAGNETIC HEATING ELEMENT, AEROSOL-GENERATING ARTICLE, AND AEROSOL-GENERATING SYSTEM

(71) Applicant: VERDEWELL INTERNATIONAL HOLDINGS LIMITED, George Town (KY)

(72) Inventors: Taowen LIU, Shenzhen (CN); Shuai WANG, Shenzhen (CN); Shuowei PI, Shenzhen (CN); Qingqing YUAN, Shenzhen (CN); Hongming ZHOU, Shenzhen (CN)

(21) Appl. No.: 18/672,178

(22) Filed: May 23, 2024

(30) Foreign Application Priority Data
May 24, 2023 (CN) 202310593848.9

(51) Int. Cl. A24F 40/465; A24F 40/42; H05B 6/10

(52) U.S. Cl. CPC A24F 40/465; A24F 40/42; H05B 6/105

(57) ABSTRACT

An electromagnetic heating element includes: a tubular side wall; and a bottom wall disposed at an end of the tubular side wall in an axial direction. The tubular side wall and the bottom wall define a vaporization cavity. The tubular side wall and/or the bottom wall is provided with a through hole connecting the vaporization cavity to an outside.

### CROSS-REFERENCE TO PRIOR APPLICATION

Priority is claimed to Chinese Patent Application No. 202310593848.9, filed on May 24, 2023, the entire disclosure of which is hereby incorporated by reference herein.

### FIELD

The present invention relates to the technical field of vaporization, and more specifically, to an electromagnetic heating element, an aerosol-generating article, and an aerosol-generating system.

### BACKGROUND

An aerosol-generating system refers to a system that uses a stored vaporization medium to form an aerosol through heating or ultrasound. The vaporizable vaporization medium generally includes a liquid, gel, paste, or solid aerosol-generating substrate.

A pot-shaped heating element is generally used to hold and heat a vaporization medium in the form of liquid, gel, or paste. The vaporization medium is in contact with an inner surface of the pot-shaped heating element. The pot-shaped heating element generates heat, and then transfers the heat to the vaporization medium, thereby heating the vaporization medium in the pot-shaped heating element. However, the vaporization medium in the pot-shaped heating element requires a specific heating time. As a result, at the beginning of inhalation, the vaporization medium cannot emit smoke immediately, and a smoke emitting speed is low.

### SUMMARY

In an embodiment, the present invention provides an electromagnetic heating element, comprising: a tubular side wall; and a bottom wall disposed at an end of the tubular side wall in an axial direction, wherein the tubular side wall and the bottom wall define a vaporization cavity, and wherein the tubular side wall and/or the bottom wall is provided with a through hole connecting the vaporization cavity to an outside.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic three-dimensional structural diagram of an aerosol-generating article according to some embodiments of the present invention;

FIG. 2 is a schematic exploded structural diagram of the aerosol-generating article shown in FIG. 1;

FIG. 3 is a schematic longitudinal-sectional structural diagram of the aerosol-generating article shown in FIG. 1;

FIG. 4 is a diagram of flow distribution of a vaporization medium in a container when the aerosol-generating article shown in FIG. 3 is heated;

FIG. 5 is a schematic diagram of a movement process of an electromagnetic heating element being pushed by bubbles in a container when the aerosol-generating article shown in FIG. 4 is heated;

FIG. 6 is a schematic longitudinal-sectional structural diagram of a first modified embodiment of an electromagnetic heating element of the present invention;

FIG. 7 is a side view of a second modified embodiment of an electromagnetic heating element of the present invention;

FIG. 8 is a schematic three-dimensional structural diagram of a third modified embodiment of an electromagnetic heating element of the present invention;

FIG. 9 is a schematic transverse-sectional structural diagram of the electromagnetic heating element shown in FIG. 8;

FIG. 10 is a schematic three-dimensional structural diagram of a fourth modified embodiment of an electromagnetic heating element of the present invention;

FIG. 11 is a schematic transverse-sectional structural diagram of the electromagnetic heating element shown in FIG. 10;

FIG. 12 is a schematic three-dimensional structural diagram of a fifth modified embodiment of an electromagnetic heating element of the present invention;

FIG. 13 is a schematic diagram of a partial structure of a modified embodiment of an aerosol-generating article of the present invention;

FIG. 14 is a schematic exploded structural diagram of the partial structure shown in FIG. 13;

FIG. 15 is a schematic three-dimensional structural diagram of a sixth modified embodiment of an electromagnetic heating element of the present invention;

FIG. 16 is a schematic longitudinal-sectional structural diagram of an aerosol-generating system according to some embodiments of the present invention;

FIG. 17 is a diagram of a relationship between a current and a Lorentz force in a first embodiment of the present invention; and

FIG. 18 is a diagram of a relationship between a current and a Lorentz force in a second embodiment of the present invention.

### DETAILED DESCRIPTION

In an embodiment, the present invention provides an improved electromagnetic heating element, and an aerosol-generating article and an aerosol-generating system with the electromagnetic heating element for the foregoing defects in the related art.

In an embodiment, the present invention provides an electromagnetic heating element that includes a tubular side wall and a bottom wall disposed at an end of the tubular side wall in an axial direction, where the tubular side wall and the bottom wall define a vaporization cavity, and the tubular side wall and/or the bottom wall is provided with a through hole connecting the vaporization cavity to the outside.

In some embodiments, the through hole is provided on the bottom wall, or

the through hole is provided on the tubular side wall, and a distance between a center line of the through hole and an end surface of the end of the tubular side wall at which the bottom wall is disposed is less than or equal to 6 mm.

In some embodiments, a surface roughness of the tubular side wall ranges from Ra0.05 to Ra25, or
a surface of the tubular side wall is provided with a uniform heat distribution layer, and a surface roughness of the uniform heat distribution layer ranges from Ra0.05 to Ra25.

In some embodiments, a surface roughness of the tubular side wall ranges from Ra0.05 to Ra6.3, or
a surface of the tubular side wall is provided with a uniform heat distribution layer, and a surface roughness of the uniform heat distribution layer ranges from Ra0.05 to Ra6.3.

In some embodiments, an outer wall surface of the tubular side wall includes a plurality of convex surfaces and a plurality of concave surfaces, and the plurality of convex surfaces and the plurality of concave surfaces all extend in the axial direction of the tubular side wall and are staggered in a circumferential direction of the tubular side wall.

In some embodiments, the tubular side wall is provided with a plurality of positioning legs protruding outward, and the plurality of positioning legs are spaced apart in a circumferential direction of the tubular side wall.

In some embodiments, the electromagnetic heating element is made of a susceptor material, or

the electromagnetic heating element includes a heating layer and a uniform heat distribution layer disposed on an outer surface of the heating layer. In some embodiments, the heating layer is made of a susceptor material, and/or the uniform heat distribution layer is made of glass glaze, ceramic, silicon carbide, or silicon nitride.

The present invention further provides an aerosol-generating article, including: a container, provided with an accommodating cavity inside;
a vaporization medium, disposed in the accommodating cavity; and the electromagnetic heating element, disposed in the accommodating cavity.

In some embodiments, the electromagnetic heating element is configured to be movable in the accommodating cavity during heating.

In some embodiments, a gap is formed between the outer wall surface of the tubular side wall and an inner wall surface of the container.

In some embodiments, a size of the gap is less than or equal to 5 mm. In some embodiments, the aerosol-generating article further includes:
a limiting member, disposed in the container, where
the limiting member includes an annular body sleeved on the tubular side wall and a plurality of limiting legs protruding outward from the annular body.

In some embodiments, the tubular side wall is movable within a range constrained by the annular body.

The present invention further provides an aerosol-generating system, including: the foregoing aerosol-generating article; and a vaporization device adapted to the aerosol-generating article; and
the vaporization device includes an induction coil coupled to the electromagnetic heating element.

Implementation of the present invention at least has the following beneficial effects. During heating, the vaporization medium in the vaporization cavity can flow out through the through hole and be in contact with the outer wall of the electromagnetic heating element, which increases a contact area between the vaporization medium and the electromagnetic heating element, is conducive to rapid smoke emission, and increases an amount of smoke. In addition, a liquid explosion phenomenon occurring after the vaporization medium is heated can be further reduced.

In order to have a clearer understanding of the technical features, the objectives, and the effects of the present invention, specific implementations of the present invention are now illustrated in detail with reference to the accompanying drawings. In the following description, many specific details are described to give a full understanding of the present invention. However, the present invention may be implemented in many other manners different from those described herein. A person skilled in the art may make similar improvements without departing from the connotation of the present invention. Therefore, the present invention is not limited to the specific embodiments disclosed below.

In the description of the present invention, it should be understood that, orientation or position relationships indicated by terms such as “longitudinal”, “transverse”, “upper”, “lower”, “top”, “bottom”, “inner”, and “outer” are orientation or position relationship shown based on the accompanying drawings or orientation or position relationship that the product of the present invention is usually placed in use, and are merely used for describing the present invention and simplifying the description, rather than indicating or implying that the mentioned apparatus or element should have a particular orientation or be constructed and operated in a particular orientation, and therefore, should not be construed as a limitation to the present invention.

In addition, the terms “first” and “second” are used for descriptive purposes only and are not to be construed as indicating or implying relative importance or implicitly indicating the number of technical features indicated. Therefore, a feature restricted by “first” or “second” may explicitly indicate or implicitly include at least one of such features. In the description of the present invention, unless otherwise explicitly defined, “a plurality of” means at least two, for example, two, three, and the like.

In the present invention, unless otherwise explicitly specified and defined, terms such as “mounted”, “connected”, “connection”, and “fixed” should be understood in a broad sense. For example, the connection may be a fixed connection, a detachable connection, or an integral connection; the connection can be mechanical or electrical or the connection may be a direct connection, an indirect connection through an intermediate medium, or internal communication between two elements or a mutual action relationship between two elements, unless otherwise explicitly specified. A person of ordinary skill in the art may understand the specific meanings of the foregoing terms in the present invention according to specific situations.

In the present invention, unless otherwise explicitly specified and defined, a first feature is “on” or “below” a second feature may mean that the first feature and the second feature are in direct, or the first feature and the second feature are in indirect contact through an intermediate medium. Moreover, that the first feature is “above” the second feature may be that the first feature is right above the second feature or at an inclined top of the second feature, or may merely indicate that the horizontal height of the first feature is higher than that of the second feature. That the first feature is “under” the second feature may be that the first feature is directly below or obliquely below the second feature, or simply indicates that a horizontal height of the first feature is less than that of the second feature.

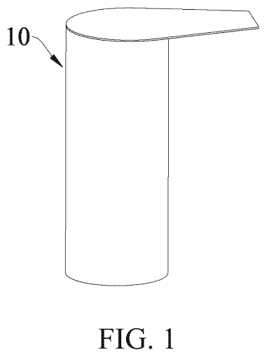

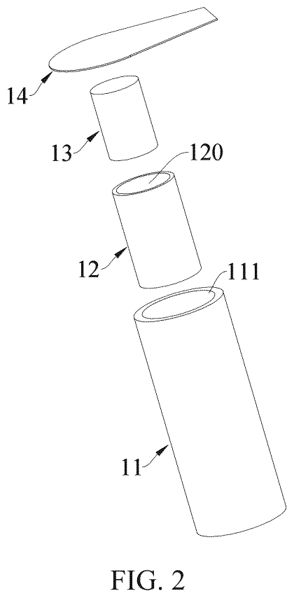

FIG. 1 to FIG. 3 show an aerosol-generating article 10 in an embodiment of the present invention. The aerosol-generating article 10 includes a container 11, and an electromagnetic heating element 12 and a vaporization medium 13 that are disposed in the container 11. The vaporization medium 13 is used to generate an aerosol after being heated. The electromagnetic heating element 12 is used to generate heat in a magnetic field to heat the vaporization medium 13.

In some embodiments, the vaporization medium 13 includes, but is not limited to, a material used for medical treatment, life nurturing, health, beauty, and other purposes. The vaporization medium 13 may include at least one of a liquid, a paste, or a gel, or may include a combination of at least one of a liquid, a paste, or a gel and a solid. The paste and the gel are in a solid or gel state at a normal temperature and become liquid after being heated to a specific temperature.

When including a solid, the vaporization medium 13 may include one or more solids in a pulverized shape, granulated shape, powdered shape, granular shape, strip shape, or flake shape. When including a plant material, the vaporization medium 13 may include one or more of a root, a stem, a leave, a flower, a bud, a seed, and the like of a plant.

The container 11 may be in a cylindrical shape. An accommodating cavity 110 is formed in the container 11, and an opening 111 is formed at an end of the container 11 to connect the accommodating cavity 110 to the outside. The outside air can enter the accommodating cavity 110 through the opening 111, and then carry the aerosol generated after the vaporization medium 13 is vaporized to flow out through the opening 111. The container 11 may be made of a high temperature resistant material, such as glass, ceramic, metal, plastic, or aluminum foil, preferably glass. In another embodiment, the container 11 is not limited to being in a cylindrical shape, and may alternatively be in an elliptical cylindrical shape, a racetrack-shaped cylindrical shape, a square cylindrical shape, a polygonal cylindrical shape, or other shapes.

A vaporization cavity 120 is formed in the electromagnetic heating element 12, and the vaporization medium 13 may be disposed in the vaporization cavity 120. The electromagnetic heating element 12 includes a susceptor material or is made of the susceptor material. The term “susceptor material” is used to describe a material that can convert electromagnetic energy into heat. When the electromagnetic heating element 12 is located in a magnetic field, the susceptor material can generate an eddy current under the influence of the magnetic field. The eddy current can heat the electromagnetic heating element 12 through ohmic or resistive heating, thereby heating the vaporization medium 13 in the electromagnetic heating element 12.

The susceptor material may include any material that can be inductively heated sufficiently to cause the vaporization medium 13 to generate an aerosol. A suitable susceptor material may include one or more of graphite, molybdenum, silicon carbide, stainless steel, niobium, aluminum, nickel, a nickel-containing compound, titanium, a metal material composite, and the like. Preferably, the susceptor material includes metal or carbon.

Further, the susceptor material may include a ferromagnetic material (for example, iron and iron-based alloys, nickel and nickel-based alloys, cobalt and cobalt-based alloys, and the like). The ferromagnetic material is capable of heating through an eddy current and hysteresis loss. In some embodiments, the ferromagnetic material may include ferritic iron, ferromagnetic alloys (for example, ferromagnetic steel or stainless steel), ferromagnetic particles, or ferrite. Preferably, the susceptor material may include 4-series stainless steel, such as 410 stainless steel, 420 stainless steel, or 430 stainless steel.

The electromagnetic heating element 12 has a tubular structure, and is in a specific shape that is not limited. In this embodiment, the electromagnetic heating element 12 includes a tubular side wall 121 in the shape of a circular tube and a bottom wall 122 disposed at an end of the tubular side wall 121 in an axial direction. Certainly, in another embodiment, the tubular side wall 121 may alternatively be in or substantially in an elliptical tubular shape, a racetrack-shaped tubular shape, a square tubular shape, a polygonal tubular shape, or other tubular shapes.

In addition, in this embodiment, the electromagnetic heating element 12 has a uniform or substantially uniform thickness. Specifically, the tubular side wall 121 and the bottom wall 122 have the same or substantially the same thickness. Certainly, in another embodiment, the tubular side wall 121 and/or the bottom wall 122 may alternatively have a non-uniform wall thicknesses.

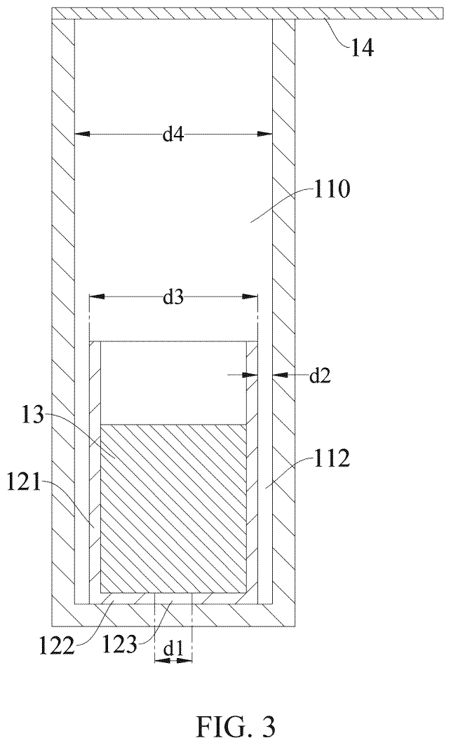

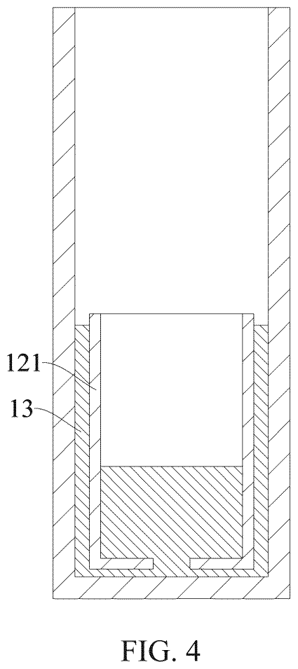

As shown in FIG. 3 and FIG. 4, a gap 112 is formed between an outer wall surface of the electromagnetic heating element 12 (a surface radially away from the vaporization cavity 120) and an inner wall surface of the container 11 (a surface radially close to the vaporization cavity 120), so that the electromagnetic heating element 12 has a specific movement space in the container 11, and the large area contact between the outer wall surface of the electromagnetic heating element 12 and the inner wall surface of the container 11 is reduced. The electromagnetic heating element 12 is further provided with a through hole 123. During heating, the vaporization medium 13 in the electromagnetic heating element 12 can flow to the gap 112 through the through hole 123.

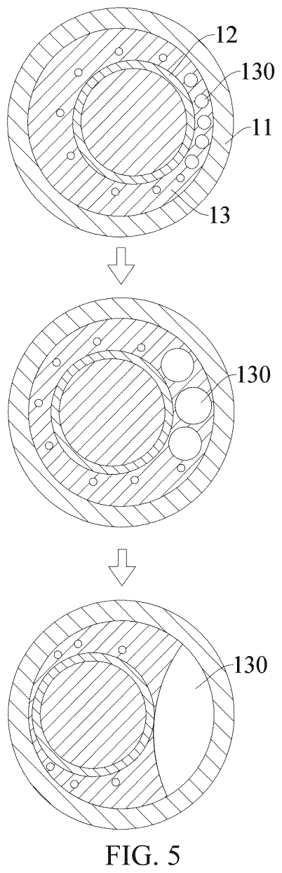

In a first aspect, the vaporization medium 13 flowing into the gap 112 can be in contact with the outer wall surface of the electromagnetic heating element 12, thereby increasing a contact area between the vaporization medium 13 and the electromagnetic heating element 12, which can significantly increase an amount of smoke. In addition, since the vaporization medium 13 in the gap 112 is relatively few, the temperature rises faster, which is beneficial to rapid smoke emission. In a second aspect, as shown in FIG. 4, a smaller gap 112 can cause the vaporization medium 13 in the gap 112 to boil and rush upward a specific distance, causing the vaporization medium 13 to continuously wash the wall surface of the electromagnetic heating element 12, thereby increasing the contact area between the outer wall surface of the electromagnetic heating element 12 and the vaporization medium 13, increasing the amount of smoke, and reducing the poor taste caused by dry heating. In a third aspect, as shown in FIG. 5, bubbles 130 generated in the heating process of the vaporization medium 13 in the gap 112 push the electromagnetic heating element 12 to move in the container 11, and can play a role in stirring the vaporization medium 13. The stirring causes the bubbles 130 to burst rapidly to release a large amount of smoke, thereby enabling rapid vaporization with relatively small power. In a fourth aspect, by providing the through hole 123, the liquid explosion phenomenon occurring after the vaporization medium in the electromagnetic heating element 12 is heated can be further reduced. In a fifth aspect, the electromagnetic heating element 12 is not fixed in the container 11, so the electromagnetic heating element 12 can also be used as a disposable consumable, eliminating a problem of cleaning. In addition, the electromagnetic heating element 12 has a simple and cheap structure and a low replacement cost.

The surface of the tubular side wall 121 of the electromagnetic heating element 12 has a specific roughness, so that the vaporization medium 13 rushing upward can stay on the surface of the tubular side wall 121 for a period of time and then flow downward naturally, which helps to reduce dry heating and increase the amount of smoke. However, the staying time of the vaporization medium 13 on the surface of the tubular side wall 121 should not be too long; otherwise carbon deposition is easily caused. In some embodiments, the surface roughness of the tubular side wall 121 may range from Ra0.05 to Ra25 (values at two ends are included), preferably from Ra0.05 to Ra6.3 (values at two ends are included).

A quantity of through holes 123 may be one or more. The shape of the through hole 123 may be any regular or irregular shape such as a circle, an ellipse, a triangle, or a polygon, and is preferably a circle or an ellipse. The through hole 123 may be disposed in a position on the tubular side wall 121 and/or the bottom wall 122. As shown in FIG. 3, in this embodiment, the through hole 123 is circular and is provided on the bottom wall 122. An aperture d1 of the through hole 123 may range from 0.5 mm to 3 mm (values at two ends are included), preferably from 0.8 mm to 1.5 mm (values at two ends are included).

The size of the gap 112 is related to the viscosity of the vaporization medium 13. In some embodiments, a size d2 of the gap 112 may be 0<d2≤5 mm, preferably 0.2 mm≤d2≤2 mm. An outer diameter d3 of the electromagnetic heating element 12 may range from 2.5 mm to 6 mm (values at two ends are included), preferably from 3.5 mm to 5 mm (values at two ends are included). An inner diameter d4 of the container 11 may range from 4 mm to 10 mm (values at two ends are included), preferably from 5.5 mm to 8 mm (values at two ends are included). The size d2 of the gap 112 refers to a distance between the outer wall surface of the electromagnetic heating element 12 and the inner wall surface of the container 11 in a case that the electromagnetic heating element 12 and the container 11 are coaxially disposed.

In some embodiments, the opening 111 of the container 11 may be further provided with a sealing film 14, such as aluminum foil. The scaling film 14 is used to seal the opening 111 to prevent the vaporization medium 13 in the container 11 from flowing out, and to prevent external impurities from entering the container 11 to ensure the cleanliness inside the container 11. In some embodiments, the sealing film 14 is peelably attached to a periphery of the opening 111 to seal the opening 111. During use, the sealing film 14 can be peeled off first to expose the opening 111. Certainly, in another embodiment, the opening 111 can alternatively be exposed by puncturing the sealing film 14.

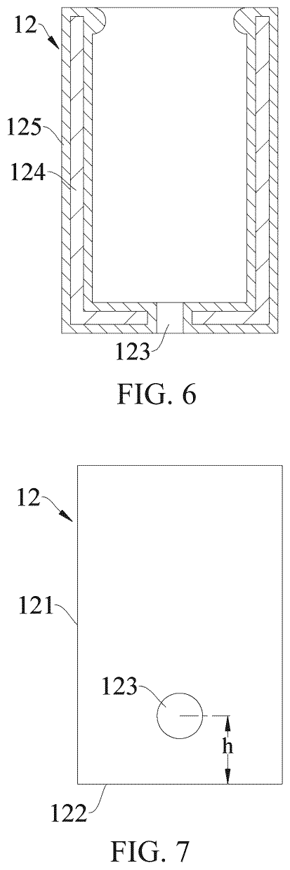

In the first modified embodiment shown in FIG. 6, the electromagnetic heating element 12 may include a heating layer 124 and a uniform heat distribution layer 125 disposed on an outer surface of the heating layer 124. The heating layer 124 includes a susceptor material for generating heat in a magnetic field, such as a ferromagnetic material. A thickness of the heating layer 124 may range from 0.05 mm to 0.5 mm (values at two ends are included), preferably from 0.2 mm to 0.35 mm (values at two ends are included). The uniform heat distribution layer 125 has a lower thermal conductivity coefficient than the heating layer 124. In some embodiments, the thermal conductivity coefficient of the uniform heat distribution layer 125 is less than or equal to 10 W/m. K, preferably less than or equal to 3 W/m. K, which is beneficial for the heat to be uniformly distributed in the electromagnetic heating element 12. The uniform heat distribution layer 125 can be made of a low thermal conductivity non-metallic material such as glass glaze, ceramic, silicon carbide, silicon nitride, or Teflon coating, preferably glass glaze. A thickness of the uniform heat distribution layer 125 may range from 5 μm to 50 μm (values at two ends are included), preferably from 10 μm to 30 μm (values at two ends are included). A surface roughness of the uniform heat distribution layer 125 may range from Ra0.05 to Ra25 (values at two ends are included), preferably from Ra0.05 to Ra6.3 (values at two ends are included).

Certainly, the electromagnetic heating element 12 may alternatively be bare magnetic, that is, the electromagnetic heating element 12 has only the heating layer 124, and at least part of the susceptor material of the electromagnetic heating element 12 is exposed.

FIG. 7 shows an electromagnetic heating element 12 in a second modified embodiment of the present invention. The main difference from the foregoing embodiment is that in this embodiment, the through hole 123 is provided on the tubular side wall 121. Preferably, the through hole 123 is provided at a position on the tubular side wall 121 that is close to the bottom wall 122, so that the vaporization medium 13 can flow out through the through hole 123 in most of the process of being heated and consumed. In some embodiments, a distance h between the center line of the through hole 123 and the bottom surface of the electromagnetic heating element 12 may be less than or equal to 6 mm, preferably 0<h≤3 mm.

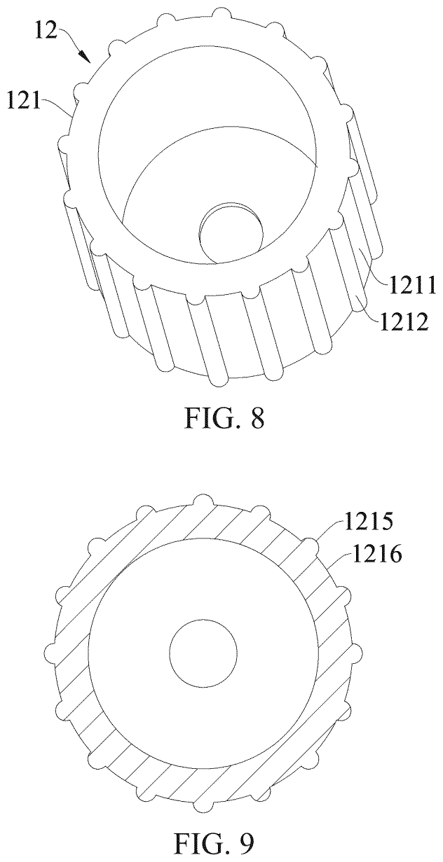

FIG. 8 and FIG. 9 show an electromagnetic heating element 12 in a third modified embodiment of the present invention. The main difference from the foregoing embodiment is that in this embodiment, the inner wall surface of the tubular side wall 121 of the electromagnetic heating element 12 is a smooth surface, and the outer wall surface of the tubular side wall 121 is uneven, so that a wall thickness of the tubular side wall 121 is non-uniform. The uneven outer wall surface can help reduce the time for which the vaporization medium 13 stays on the outer wall surface of the tubular side wall 121, thereby reducing dry heating and increasing the amount of smoke. In addition, the contact area between the electromagnetic heating element 12 being pushed by the bubbles to move and the container 11 can be reduced, which is beneficial to reduction of the heat transferred from the electromagnetic heating element 12 to the container 11.

Specifically, in this embodiment, the tubular side wall 121 may include a tubular body 1211 and a plurality of ribs 1212 extending outward from an outer wall surface of the tubular body 1211. The tubular body 1211 is in the shape of a circular tube. The plurality of ribs 1212 are uniformly spaced apart in a circumferential direction of the tubular body 1211, and each rib 1212 extends vertically downward from an upper end surface to a lower end surface of the tubular body 1211. The ribs 1212 extend in a vertical direction, which is beneficial to the flow of the vaporization medium 13. Certainly, in another embodiment, the tubular body 1211 may alternatively be in an elliptical tubular shape, a square tubular shape, a polygonal tubular shape, or other shapes.

Outer wall surfaces of the plurality of ribs 1212 form a plurality of convex surfaces 1215, and outer wall surfaces of parts of the tubular body 1211 that are located between every two adjacent ribs 1212 form a plurality of concave surfaces 1216. The plurality of convex surfaces 1215 and the plurality of concave surfaces 1216 are alternately distributed in the circumferential direction of the tubular side wall 121, and the convex surfaces 1215 are radially closer to the inner wall surface of the container 11 than the concave surfaces 1216. When the electromagnetic heating element 12 is pushed by the bubbles to move, the convex surface 1215 of the electromagnetic heating element 12 is in contact with the inner wall surface of the container 11, while the concave surface 1216 is not in contact with the inner wall surface of the container 11, thereby greatly reducing the contact area with the container 11.

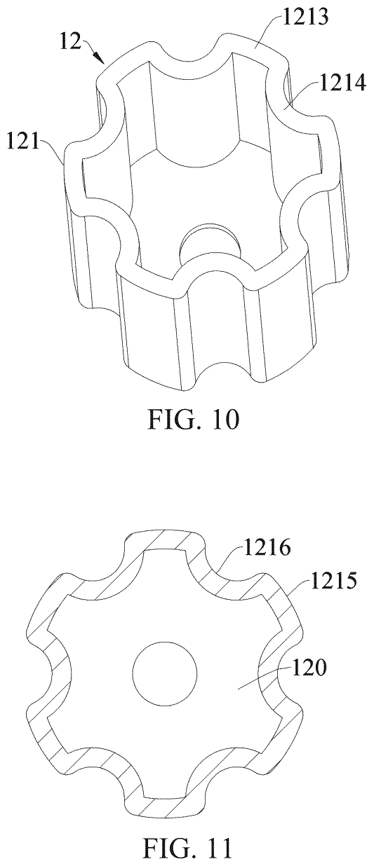

FIG. 10 and FIG. 11 show an electromagnetic heating element 12 in a fourth modified embodiment of the present invention. The main difference from the foregoing third embodiment is that in this embodiment, the tubular side wall 121 of the electromagnetic heating element 12 is in a special-shaped tubular shape, and the inner wall surface and the outer wall surface of the tubular side wall 121 are both uneven, so that the wall thickness of the tubular side wall 121 is uniform or substantially uniform.

Specifically, in this embodiment, the tubular side wall 121 includes a plurality of convex portions 1213 and a plurality of concave portions 1214 distributed alternately in the circumferential direction. The plurality of convex portions 1213 and the plurality of concave portions 1214 are connected to form the tubular side wall 121 with a uniform or substantially uniform wall thickness. Outer wall surfaces of the plurality of convex portions 1213 form a plurality of convex surfaces 1215, and outer wall surfaces of the plurality of concave portions 1214 form a plurality of concave surfaces 1216. The plurality of convex surfaces 1215 and the plurality of concave surfaces 1216 are alternately distributed in the circumferential direction of the tubular side wall 121, and the convex surfaces 1215 are radially closer to the inner wall surface of the container 11 than the concave surfaces 1216. When the electromagnetic heating element 12 is pushed by the bubbles to move, the convex surface 1215 of the electromagnetic heating element 12 is in contact with the inner wall surface of the container 11, while the concave surface 1216 is not in contact with the inner wall surface of the container 11, thereby greatly reducing the contact area with the container 11.

More specifically, in this embodiment, a connection line of cross-sectional profiles of the plurality of convex portions 1213 form a circular tubular structure. Each two convex portions 1213 are connected by one concave portion 1214, and the concave portion 1214 is arc-shaped and recessed into the vaporization cavity 120.

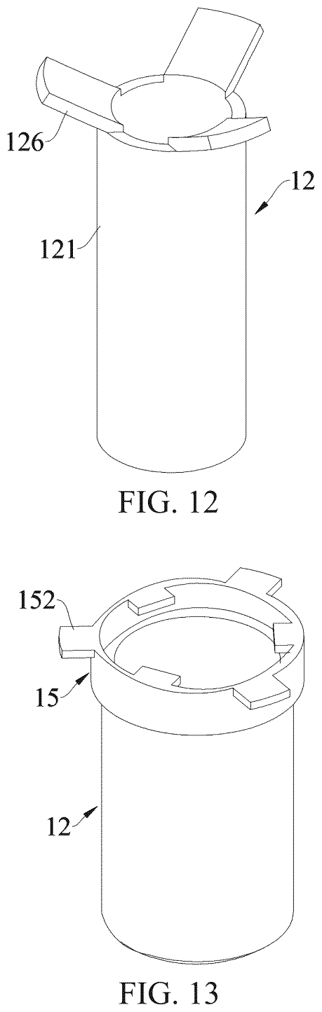

FIG. 12 shows an electromagnetic heating element 12 in a fifth modified embodiment of the present invention. The main difference from the foregoing embodiment is that in this embodiment, the tubular side wall 121 of the electromagnetic heating element 12 protrudes outward to form a plurality of positioning legs 126, and the plurality of positioning legs 126 can be spaced apart in an axial direction and/or a circumferential direction of the tubular side wall 121. Specifically, in this embodiment, the plurality of positioning legs 126 can be formed by integrally extending outward from an upper end of the tubular side wall 121 and can be uniformly spaced apart in the circumferential direction of the tubular side wall 121, which is beneficial to force uniformity, and is further beneficial to gathering the dispersed magnetic field at the upper end. The plurality of positioning legs 126 can prevent the tubular side wall 121 from being in contact with the container 11 for a long time, greatly reducing the heat transferred from the electromagnetic heating element 12 to the container 11, and preventing the container 11 from being overheated and carbonizing the medium on the container 11, without resulting in a poor taste. Preferably, a quantity of positioning legs 126 may range from 3 to 8, which facilitates processing and manufacturing. Certainly, in another embodiment, only one positioning leg 126 may alternatively be disposed. In some other embodiments, the positioning leg 126 may alternatively be disposed at a lower end or a middle portion of the tubular side wall 121 or any other position.

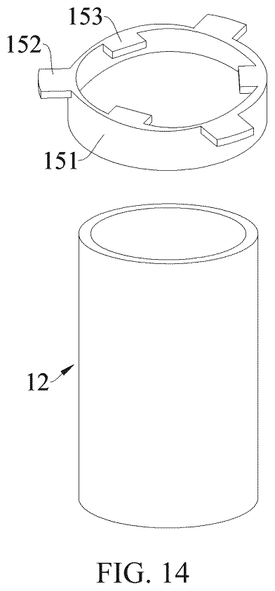

FIG. 13 and FIG. 14 show an aerosol-generating article 10 in a modified embodiment of the present invention. The main difference from the foregoing embodiment is that the aerosol-generating article 10 in this embodiment further includes a limiting member 15 sleeved on the electromagnetic heating element 12. The limiting member 15 includes at least one limiting leg 152. The at least one limiting leg 152 can prevent the tubular side wall 121 from being in contact with the container 11 for a long time, which greatly reduces the heat transferred outward by the electromagnetic heating element 12.

Specifically, in this embodiment, the limiting member 15 is sleeved on the upper end of the electromagnetic heating element 12, and may include an annular body 151 sleeved on a periphery of the tubular side wall 121, at least one limiting leg 152 protruding outward from the annular body 151, and at least one inner flange 153 protruding inward from the annular body 151. The at least one inner flange 153 can abut against an upper end surface of the tubular side wall 121 to position the limiting member 15 in the axial direction.

Preferably, there are a plurality of limiting legs 152 and a plurality of inner flanges 153 respectively, and the plurality of limiting legs 152 and the plurality of inner flanges 153 are respectively uniformly spaced apart in the circumferential direction of the annular body 151.

In an embodiment, the limiting member 15 is in contact with the container 11 through a plurality of limiting legs 152 to perform limiting. An inner diameter of the annular body 151 may be greater than an outer diameter of the tubular side wall 121, so that there is a gap between the inner wall surface of the annular body 151 and the outer wall surface of the tubular side wall 121, and the electromagnetic heating element 12 can move within the range constrained by the annular body 151.

In another embodiment, there may be no gap between the annular body 151 and the tubular side wall 121. For example, the annular body 151 and the tubular side wall 121 may be riveted and fixed together, and the limiting member 15 can be pushed by the bubbles together with the electromagnetic heating element 12 to move in the container 11. In this case, the limiting member 15 may not be provided with the inner flange 153.

Certainly, in another embodiment, the limiting member 15 may alternatively be disposed at the lower end of the electromagnetic heating element 12 or at other positions.

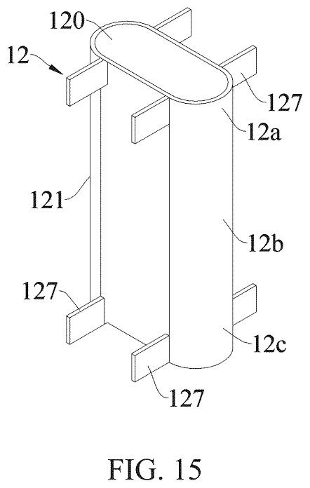

FIG. 15 shows an electromagnetic heating element 12 in a sixth embodiment of the present invention. The main difference from the foregoing embodiment is that in this embodiment, the tubular side wall 121 of the electromagnetic heating element 12 is in a racetrack-shaped tubular shape. In addition, in this embodiment, an effective cross-sectional area of a middle portion 12b of the electromagnetic heating element 12 is less than an effective cross-sectional area of an upper portion 12a and an effective cross-sectional area of a lower portion 12c at two ends of the electromagnetic heating element in the axial direction, which is beneficial to gathering the dispersed magnetic field at the two ends and improving the magnetic field utilization. In addition, through the magnetoconductivity of the electromagnetic heating element 12, a stronger magnetic field is formed in the middle portion 12b, so that more magnetic field lines are cut per unit area on the cross section of the middle portion 12b, thereby increasing the heating speed of the middle portion 12b, reducing the preheating time, and increasing the energy utilization.

The “effective cross-sectional area” refers to a cross-sectional area of a part of the electromagnetic heating element 12 that is used to transmit magnetic flux lines. In some embodiments, the effective cross-sectional area of the middle portion 12b may range from 10% to 30% (values at two ends are included) of the effective cross-sectional area of the upper portion 12a or the lower portion 12c. The effective cross-sectional areas of the upper portion 12a and the lower portion 12c may be or may not be equal.

Specifically, in this embodiment, the portions of the tubular side wall 121 located at the upper portion 12a and the lower portion 12c respectively protrude outward to form at least one protruding portion 127. The protruding portion 127 can increase the effective cross-sectional areas of the upper portion 12a and the lower portion 12c, and can further reduce the contact between the electromagnetic heating element 12 and the container 11, reduce the heat transferred from the electromagnetic heating element 12 to the container 11, and prevent the container 11 from being overheated and carbonizing the medium on the container 11, without resulting in a poor taste.

Preferably, the upper portion 12a and the lower portion 12c are each provided with a plurality of sheet-shaped protruding portions 127. The plurality of protruding portions 127 are uniformly or substantially uniformly spaced apart in the circumferential direction of the tubular side wall 121, which is more conducive to gathering the magnetic field.

Certainly, in another embodiment, only one of the upper portion 12a and the lower portion 12c may have an effective cross-sectional area greater than the effective cross-sectional area of the middle portion 12b. For example, only one of the upper portion 12a and the lower portion 12c is provided with the protruding portion 127. In some other embodiments, the effective cross-sectional area of the middle portion 12b can also be reduced by providing a through hole or a through groove in a part of the tubular side wall 121 that is located at the middle portion 12b, so that the effective cross-sectional area of the middle portion 12b is less than the effective cross-sectional area of the upper portion 12a and/or the effective cross-sectional area of the lower portion 12c.

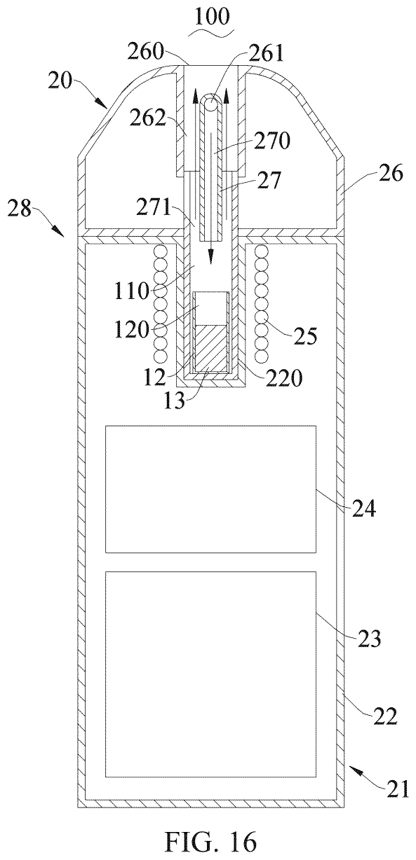

FIG. 16 shows an aerosol-generating system 100 in some embodiments of the present invention. The aerosol-generating system 100 may include an aerosol-generating article 10 and a vaporization device 20 adapted to the aerosol-generating article 10. The vaporization device 20 includes an induction coil 25 for generating a magnetic field when energized. The aerosol-generating article 10 can adopt the structure in any one of the foregoing embodiments. The aerosol-generating article 10 is designed to match the electrically operated vaporization device 20 including the induction coil 25, so that an electromagnetic heating element 12 is electromagnetically coupled to the induction coil 25 to generate heat, and the axial direction of the electromagnetic heating element 12 is substantially parallel to a direction of the magnetic field generated by the induction coil 25.

The vaporization device 20 includes a shell 28, an accommodating cavity 220 is formed in the shell 28, and the aerosol-generating article 10 is at least partially detachably accommodated in the accommodating cavity 220. When the vaporization medium 13 in the aerosol-generating article 10 is used up, the vaporization medium 13 can be updated by replacing the aerosol-generating article 10, so that the amount of the vaporization medium 13 can be accurately controlled, and portable quantitative supply of the vaporization medium 13 can be realized, which is safe and reliable, and can avoid a problem of cleaning. Certainly, in another embodiment, the container 11 and/or the electromagnetic heating element 12 of the aerosol-generating article 10 can also be reused. When the vaporization medium 13 is used up, the container 11 can also be filled with the vaporization medium 13 through a known filling device/method.

An air inlet 261 and an air outlet 260 are further formed on the shell 28. The external air enters the vaporization cavity 120 from the air inlet 261, and takes the aerosol in the vaporization cavity 120 out to the air outlet 260 with the air flow for a user to smoke or inhale.

In some embodiments, the vaporization device 20 may include a main unit 21, and the main unit 21 may include a housing 22, and a battery 23, a control module 24, and an induction coil 25 that are disposed in the housing 22. The battery 23 and the induction coil 25 are both electrically connected to the control module 24, and the battery 23 is configured to supply power to the control module 24 and the induction coil 25. The control module 24 is configured to control the battery 23 to power on and power off the induction coil 25, and can be further configured to control a magnitude and a direction of a current supplied to the induction coil 25. The induction coil 25 may be in a spiral tubular shape, and may surround the periphery of the electromagnetic heating element 12 and may be disposed coaxially with the electromagnetic heating element 12, but is not limited to being coaxially disposed.

In some embodiments, the electromagnetic heating element 12 is further configured to generate a Lorentz force in response to the magnetic field of the induction coil 25, and vibrate in the accommodating cavity 110 under the action of the Lorentz force, so that the vaporization medium 13 in the accommodating cavity 110 is stirred, and the bubbles generated when the vaporization medium 13 is heated rapidly burst to release a large amount of smoke, thereby achieving rapid vaporization.

Specifically, when the electromagnetic heating element 12 is located in a magnetic field generated by the induction coil 25, the electromagnetic heating element 12 generates an eddy current under the influence of the magnetic field. The eddy current can heat the electromagnetic heating element 12 through ohmic or resistive heating, thereby heating the vaporization medium 13. In addition, the eddy current in the electromagnetic heating element 12 can further interact with the magnetic field generated by the induction coil 25, thereby generating a Lorentz force in the electromagnetic heating element 12 and causing the electromagnetic heating element 12 to vibrate. Generally, the magnitude and/or the direction of the Lorentz force can be changed by changing the magnitude and/or the direction of the current in the induction coil 25, to control the vibration of the electromagnetic heating element 12. In some embodiments, the direction of the Lorentz force generated in the electromagnetic heating element 12 may be parallel to the axial direction of the accommodating cavity 110. When the container 11 is placed vertically, the direction of the Lorentz force generated in the electromagnetic heating element 12 can be the same as or opposite to the direction of gravity of the electromagnetic heating element 12, and an absolute value of the Lorentz force may be greater than, equal to, or less than an absolute value of the gravity. The electromagnetic heating element 12 vibrates up and down in the accommodating cavity 110 through the joint action of the Lorentz force, the gravity, an atmospheric pressure, and a buoyancy of the liquid vaporization medium. When a periodically changing current flows through the induction coil 25, the electromagnetic heating element 12 vibrates regularly in the accommodating cavity 110.

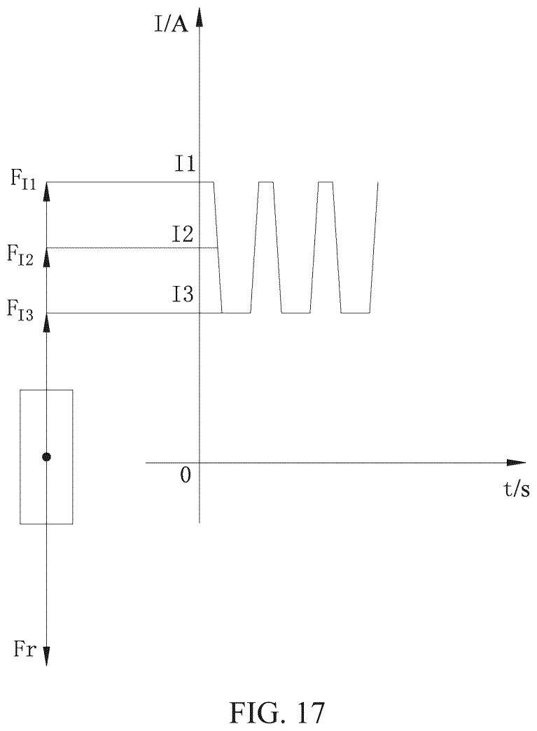

FIG. 17 shows a schematic diagram of a current in an induction coil 25 changing with time in an embodiment, in which a horizontal axis represents the time and a vertical axis represents the current. A sum of the forces acting on the electromagnetic heating element 12 except the Lorentz force is set as a resultant force Fr. In this embodiment, the current flowing through the induction coil 25 is a pulsating current, that is, the direction of the current does not change but the magnitude changes. When a pulsating current flows through the induction coil 25, the direction of the Lorentz force generated in the electromagnetic heating element 12 is opposite to the direction of the resultant force Fr of the electromagnetic heating element 12.

Specifically, the current in the induction coil 25 changes within a range from I1 to I3, where I1>I3>0. Correspondingly, the Lorentz force in the electromagnetic heating element 12 changes within a range from F_{I1} to F_{I3}. When the current I1 flows through the induction coil 25, the corresponding Lorentz force generated in the electromagnetic heating element 12 is F_{I1}. The direction of the Lorentz force F_{I1} is opposite to the direction of the resultant force Fr, and F_{I1}>−Fr. An acceleration of the electromagnetic heating element 12 is upward, and the electromagnetic heating element 12 accelerates to move upward. When the current I2 (I1>I2>I3) flows through the induction coil 25, the corresponding Lorentz force generated in the electromagnetic heating element 12 is F_{I2}. The direction of the Lorentz force Fr2 is opposite to the direction of the resultant force Fr, and F_{I2}=−Fr. The acceleration of the electromagnetic heating element 12 is 0. When the current I3 flows through the induction coil 25, the corresponding Lorentz force generated in the electromagnetic heating element 12 is F_{I3}. The direction of the Lorentz force Fr is opposite to the direction of the resultant force Fr, and F_{I3}<−Fr. The acceleration of the electromagnetic heating element 12 is downward, and the electromagnetic heating element 12 decelerates to move downward.

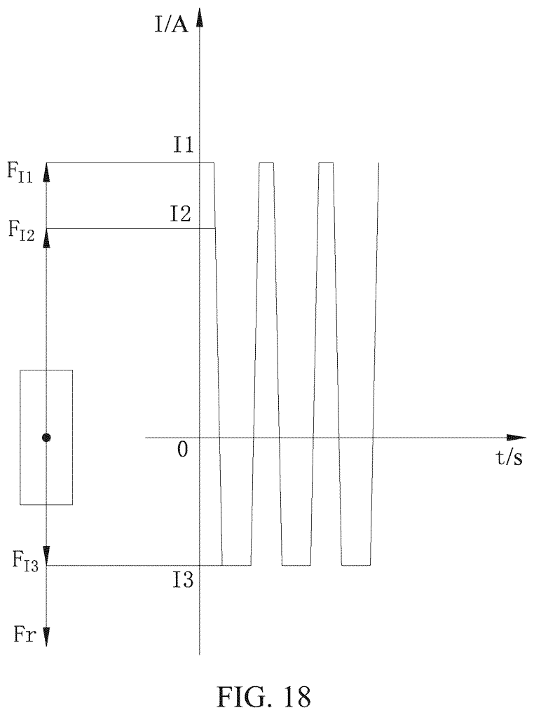

FIG. 18 shows a schematic diagram of a current in an induction coil 25 changing with time in another embodiment, in which a horizontal axis represents the time and a vertical axis represents the current. In this embodiment, the current flowing through the induction coil 25 is an alternating current, that is, both the direction and the magnitude of the current change.

The current in the induction coil 25 changes within a range from I1 to I3, where I1>−I3≥0. Correspondingly, the Lorentz force in the electromagnetic heating element 12 changes within a range from F_{I1} to F_{I3}. When the current I1 flows through the induction coil 25, the corresponding Lorentz force generated in the electromagnetic heating element 12 is F_{I1}. The direction of the Lorentz force F_{I1} is opposite to the direction of the resultant force Fr, and F_{I1}>−Fr. An acceleration of the electromagnetic heating element 12 is upward, and the electromagnetic heating element 12 accelerates to move upward. When the current I2 (I1>I2>0) flows through the induction coil 25, the corresponding Lorentz force generated in the electromagnetic heating element 12 is F_{I2}. The direction of the Lorentz force F_{I2} is opposite to the direction of the resultant force Fr, and F_{I2}=−Fr. The acceleration of the electromagnetic heating element 12 is 0. When the current I3 flows through the induction coil 25, the corresponding Lorentz force generated in the electromagnetic heating element 12 is F_{I3}. The direction of the Lorentz force F_{I3} is the same as the direction of the resultant force Fr, and −F_{I3}<−Fr. The acceleration of the electromagnetic heating element 12 is downward, and the electromagnetic heating element 12 accelerates to move downward.

As still shown in FIG. 16, in some embodiments, the vaporization device 20 may further include a suction nozzle 26 adapted to the main unit 21. The suction nozzle 26, the main unit 21, and the aerosol-generating article 10 can be detachably combined together, and the suction nozzle 26 and the main unit 21 can be reused, thereby greatly reducing the use cost of the aerosol-generating system 100.

Specifically, the suction nozzle 26 can be detachably disposed above the housing 22 in the axial direction, and forms the shell 28 of the vaporization device 20 together with the housing 22. The upper end surface of the housing 22 is recessed to form an accommodating cavity 220, and the aerosol-generating article 10 can be completely or partially accommodated in the accommodating cavity 220. An air outlet 260 is provided on a top portion of the suction nozzle 26, and an upper end of the aerosol-generating article 10 is adapted to the suction nozzle 26, so that an aerosol generated in the aerosol-generating article 10 can be output through the air outlet 260. Certainly, in another embodiment, the aerosol-generating article 10 may alternatively be fully or partially accommodated in the suction nozzle 26.

In another embodiment, the suction nozzle 26 may alternatively be mounted on the main unit 21 in a rotatable or slidable manner, and the aerosol-generating article 10 is detachably adapted between the suction nozzle 26 and the main unit 21. The aerosol-generating article 10 can also be updated by covering or exposing the aerosol-generating article 10 by rotating or sliding.

In still another embodiment, the aerosol-generating article 10 and the suction nozzle 26 may alternatively be an integrated structure. The integrated structure formed by the aerosol-generating article 10 and the suction nozzle 26 detachably matches the main unit 21, thereby eliminating a problem of cleaning the suction nozzle 26. Since the main unit 21 can be reused, and main electronic components such as the battery 23, the control module 24, and the induction coil 25 are all concentrated in the main unit 21, the replacement cost can also be reduced.

In some embodiments, the vaporization device 20 may further include a vent pipeline 27 disposed in the suction nozzle 26. The vent pipeline 27 may be integrally formed with the suction nozzle 26, or may be formed separately. A lower end of the vent pipeline 27 can extend into the container 11, an inner wall surface of the vent pipeline 27 defines a vent channel 270, and a marginal airway 271 is defined between the outer wall surface of the vent pipeline 27 and the inner wall surface of the container 11. The vent channel 270 and the marginal airway 271 are both in communication with the accommodating cavity 110 and further in communication with the vaporization cavity 120. In addition, one of the vent channel 270 and the marginal airway 271 can be used for air intake and the other is used for air exhaust.

Specifically, in this embodiment, the marginal airway 271 formed between the vent pipeline 27 and the container 11 is annular. The annular marginal airway 271 prevents contact between the vent pipeline 27 and the container 11, which is beneficial to heat insulation between the vent pipeline 27 and the container 11. Further, the marginal airway 271, the vent pipeline 27, and the accommodating cavity 110 may all be disposed coaxially. Certainly, in another embodiment, an outer wall surface of a side of the vent pipeline 27 may alternatively be in contact with an inner wall surface of a side of the accommodating cavity 110.

In some embodiments, an air inlet 261 may be further provided on the side wall of the suction nozzle 26, and a communication channel 262 may be further formed in the suction nozzle 26. The communication channel 262 may be located at an outer side of the vent pipeline 27. For example, the communication channel may include an annular airway surrounding the vent pipeline 27, or may include one or more side airways located at the outer side of the vent pipeline 27. Further, in this embodiment, two ends of the vent channel 270 are in communication with the air inlet 261 and the accommodating cavity 110 respectively, and two ends of the communication channel 262 are in communication with the marginal airway 271 and the air outlet 260 respectively.

Certainly, in another embodiment, structures of an air inlet channel and an air outlet channel in the aerosol-generating system 100 can be flexibly designed according to requirements. For example, the air inlet 261 may alternatively be provided on the housing 22, or may be formed by a matching gap between the housing 22 and the suction nozzle 26.

It may be understood that, the above technical features may be used in any combination without limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An electromagnetic heating element, comprising:
a tubular side wall; and
a bottom wall disposed at an end of the tubular side wall in an axial direction,
wherein the tubular side wall and the bottom wall define a vaporization cavity, and
wherein the tubular side wall and/or the bottom wall is provided with a through hole connecting the vaporization cavity to an outside.

2. The electromagnetic heating element of claim 1, wherein the through hole is provided on the bottom wall, or
wherein the through hole is provided on the tubular side wall, and a distance between a center line of the through hole and an end surface of the end of the tubular side wall at which the bottom wall is disposed is less than or equal to 6 mm.

3. The electromagnetic heating element of claim 1, wherein a surface roughness of the tubular side wall ranges from Ra0.05 to Ra25, or
wherein a surface of the tubular side wall is provided with a uniform heat distribution layer, and a surface roughness of the uniform heat distribution layer ranges from Ra0.05 to Ra25.

4. The electromagnetic heating element of claim 1, wherein a surface roughness of the electromagnetic heating element ranges from Ra0.05 to Ra6.3, or
wherein a surface of the tubular side wall is provided with a uniform heat distribution layer, and a surface roughness of the uniform heat distribution layer ranges from Ra0.05 to Ra6.3.

5. The electromagnetic heating element of claim 1, wherein an outer wall surface of the tubular side wall comprises a plurality of convex surfaces and a plurality of concave surfaces, and
wherein the plurality of convex surfaces and the plurality of concave surfaces all extend in the axial direction of the tubular side wall and are staggered in a circumferential direction of the tubular side wall.

6. The electromagnetic heating element of claim 1, wherein the tubular side wall is provided with a plurality of positioning legs protruding outward, and
wherein the plurality of positioning legs are spaced apart in a circumferential direction of the tubular side wall.

7. The electromagnetic heating element of claim 1, wherein the electromagnetic heating element comprises a susceptor material, or
wherein the electromagnetic heating element comprises a heating layer and a uniform heat distribution layer disposed on an outer surface of the heating layer.

8. The electromagnetic heating element of claim 7, wherein the heating layer comprises a susceptor material, and/or
wherein the electromagnetic heating element comprises the heating layer and the uniform heat distribution layer disposed on the outer surface of the heating layer, the uniform heat distribution layer comprising glass glaze, ceramic, silicon carbide, or silicon nitride.

9. An aerosol-generating article, comprising:
a container having an accommodating cavity inside;
a vaporization medium disposed in the accommodating cavity; and
the electromagnetic heating element of claim 1 disposed in the accommodating cavity.

10. The aerosol-generating article of claim 9, wherein the electromagnetic heating element is movable in the accommodating cavity during heating.

11. The aerosol-generating article of claim 9, wherein a gap is formed between an outer wall surface of the tubular side wall and an inner wall surface of the container.

12. The aerosol-generating article of claim 11, wherein a size of the gap is less than or equal to 5 mm.

13. The aerosol-generating article of claim 9, further comprising:
a limiting member disposed in the container, the limiting member comprising an annular body sleeved on the tubular side wall and a plurality of limiting legs protruding outward from the annular body.

14. The aerosol-generating article of claim 13, wherein the tubular side wall is movable within a range constrained by the annular body.

15. An aerosol-generating system, comprising:
the aerosol-generating article of claim 9; and
a vaporization device for the aerosol-generating article, the vaporization device comprising an induction coil coupled to the electromagnetic heating element.
